(19) United States
(12) Patent Application Publication
(10) Pub. No.: US 2021/0192233 A1
(43) Pub. Date: Jun. 24, 2021

(54) RADAR BLIND DRIVEWAY ASSISTANT

(71) Applicant: Continental Automotive Systems, Inc., Auburn Hills, MI (US)

(72) Inventor: James H. Critchley, Lake Orion, MI (US)

(21) Appl. No.: 16/722,013

(22) Filed: Dec. 20, 2019

(51) Int. Cl. G06K 9/00; G01S 13/86; G01S 13/93

(52) U.S. Cl. CPC G06K 9/00805; G01S 2013/932; G01S 13/93; G01S 13/867

(57) ABSTRACT

A system for detecting a moving object blocked by a visual obstruction includes a remote radar located at an intersection of an end of a driveway and a road that is near a visual obstruction. The remote radar includes a sensor to detect data about the moving object in a radar field of view and a first transceiver that sends the data obtained by the sensor about the moving object to a second transceiver. The system includes a master device including the second transceiver and a control unit that communicates with the second transceiver. The data sent to the second transceiver is sent to the control unit to obtain information about the moving object.

### TECHNICAL FIELD

The present disclosure relates to a system and method for detecting obstructed moving objects approaching an end of a driveway.

### BACKGROUND

Objects near a driveway can obstruct a view of a road, making it difficult for a vehicle to pull out from the driveway or back out onto the road from the driveway.

### SUMMARY

A system for detecting a moving object blocked by a visual obstruction according to an exemplary embodiment of this disclosure, includes, among other possible things, a remote radar located at an intersection of an end of a driveway and a road that is near a visual obstruction. The remote radar includes a sensor to detect data about the moving object in a radar field of view and a first transceiver that sends the data obtained by the sensor about the moving object to a second transceiver. The system includes a master device including the second transceiver and a control unit that communicates with the second transceiver. The data sent to the second transceiver is sent to the control unit to obtain information about the moving object.

In a further embodiment of the foregoing system, the moving object is a vehicle. In a further embodiment of the foregoing system, the visual obstruction is a tree, a wall, or a parked car. In a further embodiment of the foregoing system, the information about the moving object is shown on a display. In a further embodiment of the foregoing system, the display is a phone or a tablet. In a further embodiment of the foregoing system, the display is a vehicle display of a vehicle. In a further embodiment of the foregoing system, the information about the moving object is at least one of a distance of the moving object, a speed of the moving object, and a time until the moving object will cross the remote infrastructure radar. In a further embodiment of the foregoing system, the information about the moving object is a visual symbol. In a further embodiment of the foregoing system, the information about the moving object supplements GPS information. In a further embodiment of the foregoing system, the control unit sends a first signal to the second transceiver of the master device, the second transceiver of the master device sends a second signal to the first transceiver of the remote radar, and the first transceiver of the remote radar sends a third signal to the sensor to activate the sensor to obtain the data about the moving object. In a further embodiment of the foregoing system, the control unit generates at least one of an audible warning, a visual warning, and a tactical warning when the moving object is detected.

Another system for detecting a moving vehicle blocked by a visual obstruction according to an exemplary embodiment of this disclosure includes, among other possible things, a remote radar located at an intersection of an end of a driveway and a road that is near a visual obstruction. The remote radar includes a sensor to detect data about the moving vehicle in a radar field of view and a first transceiver that sends the data obtained by the sensor about the moving vehicle to a second transceiver. The system includes a master device including the second transceiver, a control unit that communicates with the second transceiver, and a display. The data sent to the second transceiver is sent to the control unit to obtain information about the moving vehicle that is shown on the display, the control unit sends a first signal to the second transceiver, the second transceiver sends a second signal to the first transceiver, and the first transceiver sends a third signal to the sensor to the sensor to activate the sensor to obtain the data about the moving vehicle.

In a further embodiment of the foregoing system, the visual obstruction is a tree, a wall, or a parked car. In a further embodiment of the foregoing system, the display is a phone, a tablet or vehicle display of a vehicle. In a further embodiment of the foregoing system, the information about the moving vehicle is at least one of a distance of the moving vehicle, a speed of the moving vehicle, and a time until the moving vehicle will cross the remote infrastructure radar. In a further embodiment of the foregoing system, the information about the moving vehicle is a visual symbol. In a further embodiment of the foregoing system, the information about the moving vehicle supplements GPS information.

A method for detecting a moving object blocked by a visual obstruction according to an exemplary embodiment of this disclosure includes, among other possible things, sending a signal from a control unit to a remote radar to activate a sensor, wherein the remote radar is located at an intersection of an end of a driveway and a road and near a visual obstruction, obtaining data about the moving object from the sensor when the moving object passes through a radar field of view, sending the data from the sensor to the control unit to obtain information about the moving object, and displaying the information about the moving object.

These and other features disclosed herein can be best understood from the following specification and drawings, the following of which is a brief description.

### BRIEF DESCRIPTION OF THE DRAWINGS

FIG. 1 illustrates a radar driveway assistant system including a remote infrastructure radar located near an intersection of a driveway and a road in a rural or residential area to detect a moving object blocked by an obstruction;

FIG. 2 illustrates a radar driveway assistant system including a high mount remote infrastructure radar located near an intersection of a driveway and a road with on-street parking in an urban area to detect a moving object over a parked vehicle;

FIG. 3 illustrates a schematic overhead view of the radar driveway assistant system including a master device and the remote infrastructure radar communicating with each other;

FIG. 4 is a flow diagram of a method of detecting a moving object blocked by an obstruction;

FIG. 5 illustrates a display showing data relating to a moving object detected by the remote infrastructure radar; and

FIG. 6 illustrates a display showing data relating to a moving object detected by the remote infrastructure radar integrated with a vehicle navigation display.

### DESCRIPTION

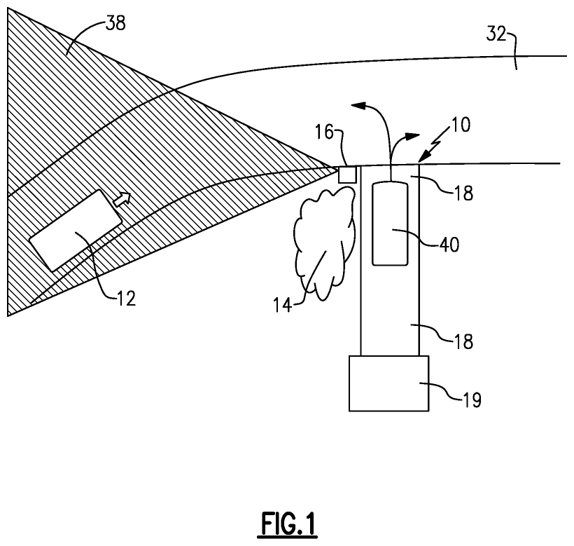

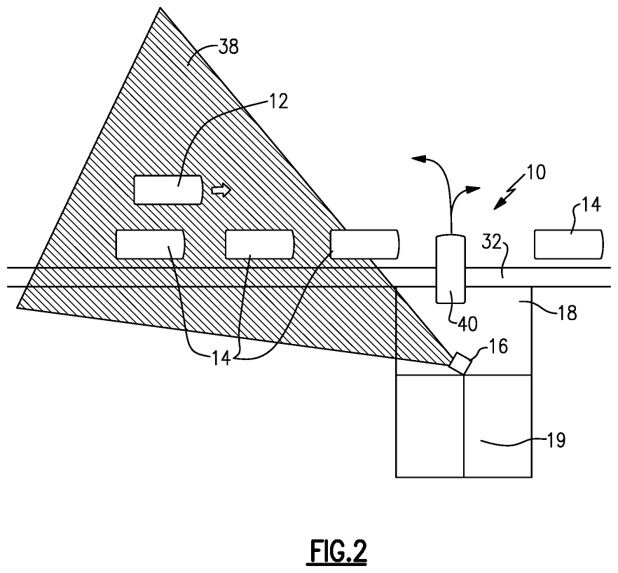

FIGS. 1 and 2 illustrate a radar driveway assistant system 10 to detect a moving object 12 blocked by a visual obstruction 14. The moving object 12 is located in a radar field of view 38. The moving object 12 can be a vehicle, a bicycle, an animal, or any object.

The radar driveway assistant system 10 includes a remote infrastructure radar 16 located near an end of a driveway 18 leaving a building 19. The remote infrastructure radar 16 can be positioned near the obstruction 14. In one example, the remote infrastructure radar 16 is an inexpensive automotive radar. The remote infrastructure radar 16 runs and broadcasts a radar object environment to a master device 20, such as a smart device (for example, a phone or tablet) or a vehicle computer of a vehicle 40.

In the example of FIG. 1, the driveway 18 is a residential or rural driveway, and the building 19 is a home in a residential or rural area. The remote infrastructure radar 16 is positioned at an end of a driveway 18 at a location where the driveway 18 meets a road 32. In the example shown, the obstruction 14 is a tree or a wall, but the obstruction 14 can be any type of object.

In the example of FIG. 2, the driver of the vehicle 40 exits the driveway 18, and the building 19 is a garage or any type of building in an urban area. The remote infrastructure radar 16 is positioned at an end of a driveway 18 or exit to the building 19 at a location where the driveway 18 meets the road 32. In this example, the remote infrastructure radar 16 is highly mounted due to the possibility of obstructions 14 such as street parked vehicles.

As the remote infrastructure radar 16 is fixed, the radar driveway assistant system 10 can adaptively learn a curvature of the road 32 (and expected trajectories of inbound moving objects 12, enabling and accurate rendering of a dynamic environment). In another example, weather or lighting limitations can be taken into account in determining the location of a moving object 12.

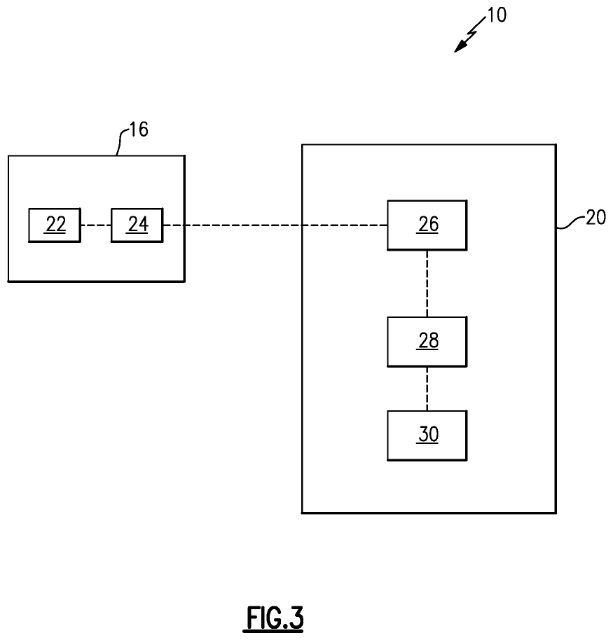

As shown in FIG. 3, the remote infrastructure radar 16 includes a blind-drive sensor 22 that obtains data about a moving object 12 and communicates with a transceiver 24. In one example, a camera or lidar can be used to obtain data about the moving object 12. The remote infrastructure radar 16 may also include a control unit.

The master device 20 includes a transceiver 26 that communicates with the transceiver 24 of the remote infrastructure radar 16 and a control until 28 that communicates with the transceiver 26. The control unit 28 can compile the data obtained from the sensor 22 and provide this information to be shown on a display 30 of the master device 20. The master device 20 can include a processing unit (not shown).

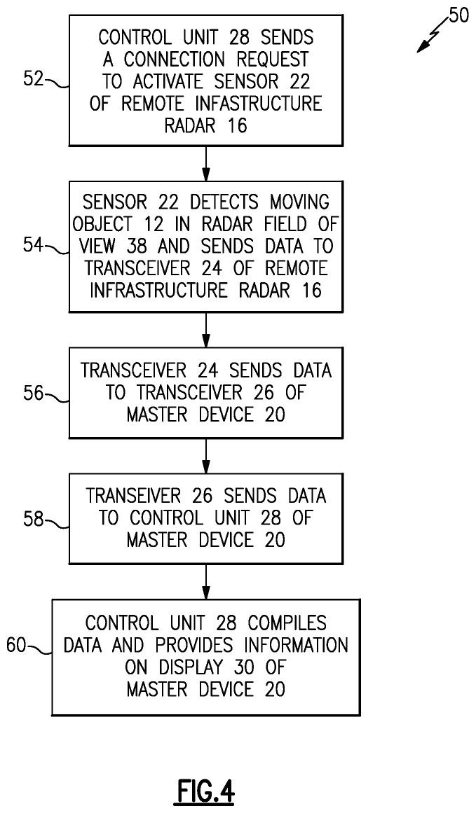

FIG. 4 illustrates a flow diagram of a method 50 of detecting a moving object 12 in the radar field of view 38 blocked by an obstruction 14. When the vehicle 20 is within range of the remote infrastructure radar 16, the control unit 28 of the master device 20 sends a connection request to the remote infrastructure radar 16 at step 52. During this step, the control unit 28 transmits a signal to the transceiver 26 of the control unit 20, which transmits the signal to the transceiver 24 of the remote infrastructure radar 16, which transmits the signal to the sensor 22. The sensor 22 activates, wakes-up, or turns-on when the connection request is received from the control unit 28.

At step 54, when a moving object 12 enters the radar field of view 38, the sensor 22 detects the moving object 12 and sends a signal including data about the moving object 12 to the transceiver 24 of the remote infrastructure radar 16. At step 56, the transceiver 24 of the remote infrastructure radar 16 then sends a signal including the data about the moving object 12 in the radar field of view 38 to the transceiver 26 of the master device 20. At step 58, the transceiver 26 of the master device 20 sends a signal including the data about the moving object 12 in the radar field of view 38 to the control unit 28 of the master device 20. Finally, in step 60, the control unit 28 compiles the data about the moving object 12 in the radar field of view 38 and displays information and/or a visual about the moving object 12 on the display 30.

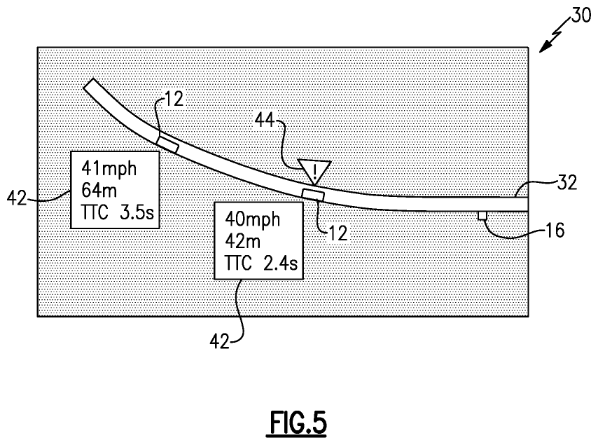

As shown in FIG. 5, when the control unit 28 obtains the data about the moving object 12, information 42 or a notification can then be shown on the display 30, such as a phone, a tablet, or a vehicle display in the vehicle 40. The information 42 can include audible, visual, and/or tactical warnings about a moving object 12. The information 42 can also include a message and/or information about the moving object 12, such as the distance, the speed, and the time until the moving object 12 will cross the remote infrastructure radar 16 (time to crossing or TTC). A visual alert 44, such as a pre-designated symbol, can also be shown on the display 30 to indicate that a moving object 12 is in the radar field of view 38.

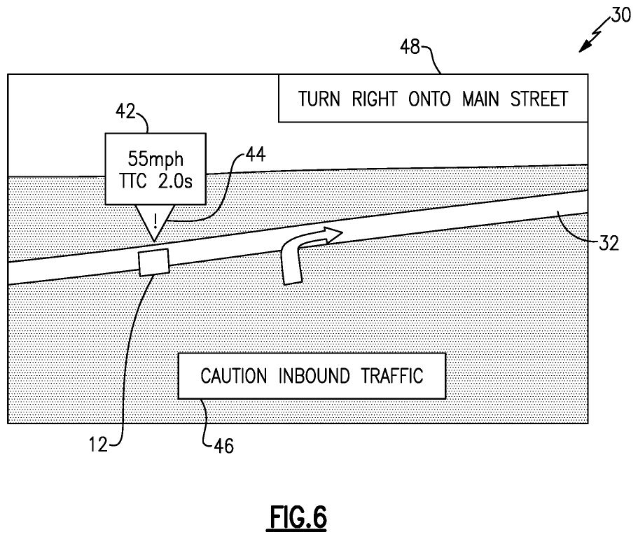

As shown in FIG. 6, a GPS style interface can also be shown on the display 30. The radar driveway assistant system 10 can enhance an arbitrary navigation system including GPS information 48 with an overlay of information 42 relating to an inbound moving object 12 on the display 30. In this example, the information 42 about the moving object 12 can supplement the GPS information 48 already displayed as part of a GPS system on the display 30. The radar driveway assistant system 10 can be configured with a GPS location and broadcast a basic safety message (BSM) regarding a moving object 12, working through vehicle to vehicle (V2V) (such as Dedicated Short Range Communications or DSRC) capabilities of the vehicle 40.

In one example, the control unit 28 or system controller can include a processor, memory, and one or more input and/or output (I/O) device interface(s) that are communicatively coupled via a local interface. The local interface can include, for example but not limited to, one or more buses and/or other wired or wireless connections. The controller may be a hardware device for executing software, particularly software stored in memory. The controller can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. The controller can be configured to execute software stored within the memory, to communicate data to and from the memory, and to generally control operations of the computing device pursuant to the software. Software in memory, in whole or in part, is read by the processor, perhaps buffered within the processor, and then executed.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason, the following claims should be studied to determine the true scope and content of this invention.

What is claimed is:

1. A system for detecting a moving object blocked by a visual obstruction comprising:
a remote radar located at an intersection of an end of a driveway and a road that is near a visual obstruction, wherein the remote radar includes a sensor to detect data about the moving object in a radar field of view and a first transceiver that sends the data obtained by the sensor about the moving object to a second transceiver; and
a master device including the second transceiver and a control unit that communicates with the second transceiver, wherein the data sent to the second transceiver is sent to the control unit to obtain information about the moving object.

2. The system as recited in claim 1 wherein the moving object is a vehicle.

3. The system as recited in claim 1 wherein the visual obstruction is a tree, a wall, or a parked car.

4. The system as recited in claim 1 wherein the information about the moving object is shown on a display.

5. The system as recited in claim 4 wherein the display is a phone or a tablet.

6. The system as recited in claim 4 wherein the display is a vehicle display of a vehicle.

7. The system as recited in claim 4 wherein the information about the moving object is at least one of a distance of the moving object, a speed of the moving object, and a time until the moving object will cross the remote infrastructure radar.

8. The system as recited in claim 4 wherein the information about the moving object is a visual symbol.

9. The system as recited in claim 4 wherein the information about the moving object supplements GPS information.

10. The system as recited in claim 1 wherein the control unit sends a first signal to the second transceiver of the master device, the second transceiver of the master device sends a second signal to the first transceiver of the remote radar, and the first transceiver of the remote radar sends a third signal to the sensor to activate the sensor to obtain the data about the moving object.

11. The system as recited in claim 1 wherein the control unit generates at least one of an audible warning, a visual warning, and a tactical warning when the moving object is detected.

12. A system for detecting a moving vehicle blocked by a visual obstruction comprising:
a remote radar located at an intersection of an end of a driveway and a road that is near a visual obstruction, wherein the remote radar includes a sensor to detect data about the moving vehicle in a radar field of view and a first transceiver that sends the data obtained by the sensor about the moving vehicle to a second transceiver; and
a master device including the second transceiver, a control unit that communicates with the second transceiver, and a display, wherein the data sent to the second transceiver is sent to the control unit to obtain information about the moving vehicle that is shown on the display, and the control unit sends a first signal to the second transceiver, the second transceiver sends a second signal to the first transceiver, and the first transceiver sends a third signal to the sensor to the sensor to activate the sensor to obtain the data about the moving vehicle.

13. The system as recited in claim 12 wherein the visual obstruction is a tree, a wall, or a parked car.

14. The system as recited in claim 12 wherein the display is a phone, a tablet or vehicle display of a vehicle.

15. The system as recited in claim 12 wherein the information about the moving vehicle is at least one of a distance of the moving vehicle, a speed of the moving vehicle, and a time until the moving vehicle will cross the remote infrastructure radar.

16. The system as recited in claim 12 wherein the information about the moving vehicle is a visual symbol.

17. The system as recited in claim 12 wherein the information about the moving vehicle supplements GPS information.

18. A method for detecting a moving object blocked by a visual obstruction comprising:
sending a signal from a control unit to a remote radar to activate a sensor, wherein the remote radar is located at an intersection of an end of a driveway and a road and near a visual obstruction;
obtaining data about the moving object from the sensor when the moving object passes through a radar field of view;
sending the data from the sensor to the control unit to obtain information about the moving object; and
displaying the information about the moving object.
